(19) United States
(12) Patent Application Publication
(10) Pub. No.: US 2014/0221571 A1
(43) Pub. Date: Aug. 7, 2014

(54) RESIN COMPOSITION AND OPTICAL FILM FORMED USING THE SAME

(71) Applicant: LG CHEM, LTD., Seoul (KR)

(72) Inventors: Jun-Geun Um, Daejeon-si (KR); Nam-Jeong Lee, Daejeon-si (KR); Sang-Min Kwak, Daejeon-si (KR); Beom-Seok Kim, Daejeon-si (KR); Suk-Il Youn, Gwangmyeong-si (KR)

(73) Assignee: LG CHEM, LTD., Seoul (KR)

(21) Appl. No.: 14/346,198

(22) PCT Filed: Sep. 26, 2012
(86) PCT No.: PCT/KR2012/007752

§ 371 Date: Mar. 20, 2014

(30) Foreign Application Priority Data
Oct. 4, 2011 (KR) 10-2011-0100837

(51) Int. Cl. G02B 1/04

(52) U.S. Cl. CPC G02B 1/04
USPC 525/148

(57) ABSTRACT

There are provided a resin composition and an optical film formed using the same, and more particularly, to a resin composition comprising a copolymer including alkyl(meth)acrylate units and styrene units and an aromatic resin having carbonate moieties in the main chain, and an optical film formed using the same. Further, a resin composition according to the present invention can provide an optical film which is excellent in optical properties and has superior optical transparency, less haze and superior mechanical strength and superior heat resistance at the same time. Therefore, an optical film formed using a resin composition of the present invention can be used in various applications, e.g., information electronic devices such as display devices.

### TECHNICAL FIELD

The present invention relates to a resin composition and an optical film formed using the same, and more particularly, to a resin composition comprising a copolymer including alkyl(meth)acrylate units and styrene units, and an aromatic resin having carbonate moieties in the main chain, and a protection film for polarizing plate formed using the same.

### BACKGROUND ART

LCDs as optical display devices have become widespread, since Liquid Crystal Displays (LCDs) have low power consumption than Cathode-Ray Tube (CRT) display and small volumes and are relatively light, such that they can be easily handled. In general, LCDs have a basic configuration in which polarizing plates are installed on both sides of liquid crystal cells, and the alignment of liquid crystal cells changes according to whether or not an electrical field has been applied to the driving circuit. Visualization of light is accomplished as characteristics of light transmitted through a polarizing plate vary accordingly.

In general, the polarizing plate comprises various components, wherein a polarizer-protecting film is adhered to both sides of the polarizer through an adhesive. A polarization film-protecting film is adhered to one side of a polarization film through an adhesive, a wide viewing angle retardation film is adhered to the other side of the polarization film, and a releasing protection film is adhered to the wide viewing angle retardation film through a pressure sensitive adhesive layer.

A polarizer in which iodine or a dichromatic dye has been adsorbed into a hydrophilic polymer such as polyvinyl alcohol (PVA) and the iodine or dichromatic dye-adsorbed hydrophilic polymer has been stretched and oriented is used. A polarizer-protecting film is used in order to enhance durability and mechanical properties of the polarizer, wherein it is important optical properties such as polarization properties of the polarizer should be maintained in the polarizer-protecting film. Therefore, transparency and isotropy are optically required in the polarizer-protecting film, and heat resistance and adhesive strength between a pressure sensitive adhesive/an adhesive act as important factors in the polarizer-protecting film.

A polarizer, a polarizer-protecting film, a releasing protection film, a wide viewing angle retardation film and others within the polarizing plate are adhered to one another by an adhesive or a pressure sensitive adhesive, and adhesive strength between the respective films acts as an important factor in influencing optical properties and durability of the polarizing plate.

Cellulose based films such as triacetyl cellulose-based films, polyester-based films, polyacrylate-based films, polycarbonate-based films, cyclic olefin-based films, norbornene-based films and others may be applied as the polarizer-protecting film based on required properties of the polarizer-protecting film. In particular, triacetyl cellulose based films are most widely used.

However, the triacetyl cellulose based films have a problem in that retardation values are revealed according to the action of external stress, since retardation values of the triacetyl cellulose based films in the thickness direction are relatively large, even in the case that in-plane retardation values of the triacetyl cellulose based films are small. In particular, the triacetyl cellulose based films have problems in that water vapor permeability levels are increased, due to many hydrophilic functional groups being formed in the molecular chain structure, thereby causing deformation of the protection film in hot or humid conditions, or a dissociation of iodine ions in the polarizer, resulting in a reduction in polarization performance thereof. In particular, during a high temperature, high humidity test, deformation of the triacetyl cellulose based films reveals nonuniform optical anisotropy in the films, resulting in the generation of problems such as a light-leakage phenomenon.

On the other hand, even in the case that acryl based resins such as polymethyl(meth)acrylate are known to be materials having excellent transparency and optical isotropy, it is considered that acryl-based resins are easily broken due to their vulnerability to external shocks, and polarization performance of the polarizing plate may be reduced in high temperature and high humidity conditions due to low heat resistance.

### DISCLOSURE

### Technical Problem

An aspect of the present invention provides a resin composition for preparing an optical film having excellent optical properties as well as superior strength and durability such as heat resistance, at the same time.

Another aspect of the present invention provides an optical film prepared using a resin composition.

### Technical Solution

According to an aspect of the present invention, there is provided a resin composition comprising (A) a copolymer including (a) alkyl(meth)acrylate units and (b) styrene units, and (B) an aromatic resin having carbonate moieties in the main chain.

Alkyl moieties of the (a) alkyl(meth)acrylate units may be a methyl group or an ethyl group.

The (b) styrene units may comprise substituted styrene wherein a benzene ring or vinyl groups of the styrene is substituted with one or more substituents selected from groups consisting of C₁₋₄ alkyl and halogen groups.

The (B) aromatic resin having carbonate moieties in the main chain may include 5 to 10,000 of at least one species of unit represented by the following formula I, wherein X is a bivalent group including at least one benzene ring.

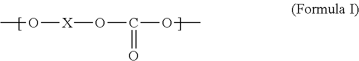

wherein X is preferably a bivalent group selected from the group consisting of the following structural formulas:

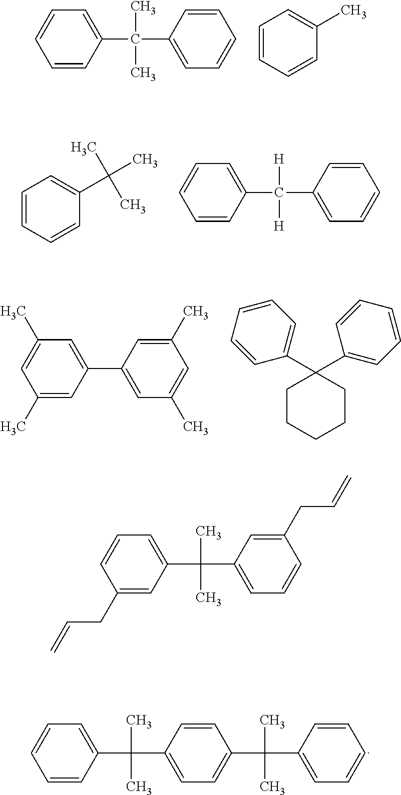

It is preferable that the copolymer (A) and the aromatic resin (B) are mixed in a weight ratio of 90:10 to 99.5:0.5.

It is preferable that the copolymer (A) additionally includes (c) 3 to 6 element heterocyclic units substituted with at least one carbonyl group.

The foregoing (c) 3 to 6 element heterocyclic units substituted with at least one carbonyl group are preferably selected from the group consisting of maleic anhydride, maleimide, glutaric anhydride, glutarimide, lactone, and lactam.

The copolymer (A) preferably comprises a combination of 2 member copolymers selected from the group consisting of (a) alkyl(meth)acrylate units, (b) styrene units, and (c) 3 to 6 element heterocyclic units substituted with at least one carbonyl group.

The copolymer (A) preferably comprises 80 to 99.9 parts by weight of (a) alkyl(meth)acrylate units and 0.1 to 20 parts by weight of (b) styrene units with respect to 100 parts by weight of the copolymer.

The copolymer (A) preferably comprises 80 to 99.9 parts by weight of (a) alkyl(meth)acrylate units, 0.1 to 10 parts by weight of (b) styrene units, and 0.1 to 10 parts by weight of (c) 3 to 6 element heterocyclic units substituted with at least one carbonyl group with respect to 100 parts by weight of the copolymer.

It is preferable that the copolymer (A) and the aromatic resin (B) be mixed in a weight ratio of 90:10 to 99.5:0.5.

The resin composition is preferably a compound resin.

According to another aspect of the present invention, there is provided an optical film formed using the resin composition. The optical film is preferably a polarizing plate-protecting film.

### Advantageous Effects

A resin composition according to the present invention can provide an optical film which is excellent in optical properties and has superior optical transparency, low haze and superior mechanical strength and superior heat resistance at the same time. Therefore, an optical film formed using a resin composition of the present invention can be used in various applications, e.g., information electronic devices such as display devices.

### BEST MODE

Hereinafter, embodiments of the present invention will be described in detail. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

The present invention provides a resin composition comprising (A) a copolymer including (a) alkyl(meth)acrylate units and (b) styrene units, and (B) an aromatic resin having carbonate moieties in the main chain.

In the present invention, the (a) alkyl(meth)acrylate units can give negative in-plane retardation values (Rᵢₙ) and negative thickness-directional retardation values (Rₜₕ) to weak degrees to films, and the styrene units can give negative in-plane retardation values (Rᵢₙ) and negative thickness-directional retardation values (Rₜₕ) to strong degrees to the films in the stretching process. On the other hand, the (B) aromatic resin having carbonate moieties in the main chain can give properties such as positive in-plane retardation values (Rᵢₙ) and positive thickness-directional retardation values (Rₜₕ) to the films.

The negative in-plane retardation values mean that refractive indexes are highest in the direction perpendicular to a stretching direction in the plane, the positive in-plane retardation values mean that refractive indexes are highest in the stretching direction, the negative thickness-directional retardation values mean that thickness-directional refractive indexes are higher than a plane-directional average refractive index, and the positive thickness-directional retardation values mean that the plane-directional average refractive index is higher than the thickness-directional refractive indexes.

Retardation properties of an optical film prepared from the resin composition may be varied by properties of each of the above-mentioned units according to composition, stretching direction, stretching ratio and stretching method of each of the components. Therefore, an optical film which can be used particularly as a zero retardation film, i.e., a protection film, may be prepared by the present invention, by controlling the composition and stretching method of the respective components.

The copolymer in the present specification means that elements mentioned as “units” in the present specification are polymerized into monomers such that the monomers as repeating units are included in the copolymer resin. Although examples of types of the copolymer may include a block copolymer and a random copolymer in the present specification, the types of the copolymer are not limited to those of the examples.

In the present specification, ‘alkyl(meth)acrylate units’ mean that they may include both ‘alkyl acrylate units’ and ‘alkyl methacrylate units’. Alkyl moieties of the alkyl(meth)acrylate units preferably have 1 to 4 carbon atoms, and are more preferably a methyl group or an ethyl group. Although the alkyl methacrylate units are more preferably methyl methacrylate, they are not limited thereto.

Although non-substituted styrene units can be used as the (b) styrene units in the present invention, the (b) styrene units comprise substituted styrene wherein a benzene ring or vinyl groups of the styrene is substituted with one or more substituents selected from groups consisting of aliphatic hydrocarbons and hetero atoms. More specifically, units substituted with C₁₋₄ alkyl or halogen groups can be used as the styrene units. More preferably, one or more selected from the group consisting of α-methyl styrene, p-bromo styrene, p-methyl styrene and p-chloro styrene may be used as the styrene units. Most preferably, one or more selected from the group consisting of styrene, α-methyl styrene, and p-methyl styrene may be used as the styrene units.

In the present invention, the (B) aromatic resin having carbonate moieties in the main chain comprises preferably 5 to 10,000 of at least one species of unit represented by the following formula I:

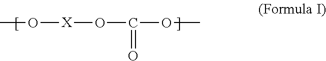

wherein X is a bivalent group comprising at least one benzene ring. More specifically, X is preferably a bivalent group selected from the group consisting of the following structural formulas:

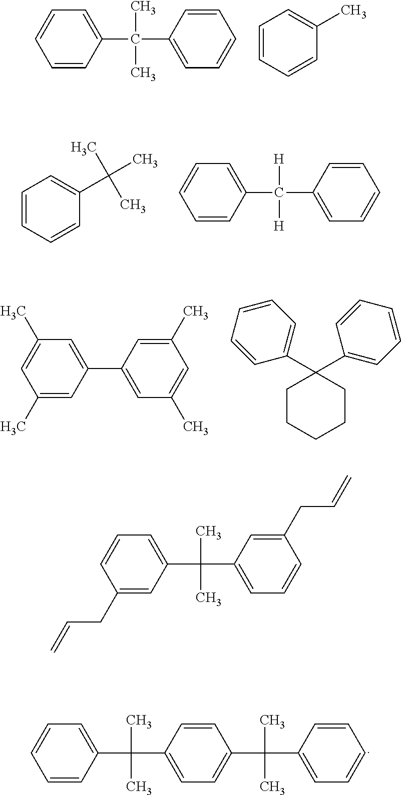

The copolymer (A) preferably comprises 80 to 99.9 parts by weight of (a) alkyl(meth)acrylate units and 0.1 to 20 parts by weight of (b) styrene units with respect to 100 parts by weight of the copolymer. There is a problem that transparency of the optical film is impeded if the copolymer (A) comprises less than 80 parts by weight of (a) alkyl(meth)acrylate units, and there may be a problem in that heat resistance of the optical film if the copolymer (A) may comprise more than 99.9 parts by weight of (a) alkyl(meth)acrylate units. On the other hand, there is a problem in controlling a retardation of the optical film if the copolymer (A) comprises less than 0.1 part by weight of (b) styrene units, and there is a problem in properties of mixing with the aromatic resin if the copolymer (A) comprises more than 20 parts by weight of (b) styrene units.

It is preferable that the copolymer (A) and the aromatic resin (B) are mixed in a weight ratio of 90:10 to 99.5:0.5, and it is more preferable that the copolymer (A) and the aromatic resin (B) are mixed in a weight ratio of 95:5 to 99:1. There is a problem in controlling a retardation of the optical film if the copolymer is mixed with the aromatic resin to a mixing ratio that is less than the above-mentioned weight ratio, and there is a problem in properties of mixing the copolymer with the aromatic resin to result in a reduction in transparency of the optical film if the copolymer is mixed with the aromatic resin in to a mixing ratio that is higher than the above-mentioned weight ratio.

Further, it is preferable that the copolymer (A) additionally includes (c) 3 to 6 element heterocyclic units substituted with at least one carbonyl group, and the heterocyclic units may be selected from the group consisting of maleic anhydride, maleimide, glutaric anhydride, glutarimide, lactone, and lactam. The 3 to 6 element heterocyclic units substituted with at least one carbonyl group may provide a film prepared by the resin composition with superior heat resistance. Additionally, the above-listed units represent superior compatibility with the aromatic resin, and compatibility of the copolymer and aromatic resin can be improved if the copolymer is comprised of the above-listed (c) units and (a) alkyl(meth)acrylate units.

It is preferable that the copolymer (A) further comprising (c) 3 to 6 element heterocyclic units substituted with at least one carbonyl group comprises 80 to 99.9 parts by weight of (a) alkyl(meth)acrylate units, 0.1 to 10 parts by weight of (b) styrene units, and 0.1 to 10 parts by weight of (c) 3 to 6 element heterocyclic units substituted with at least one carbonyl group with respect to 100 parts by weight of the copolymer.

There is a problem that transparency of the optical film is impeded if the copolymer (A) comprises less than 80 parts by weight of (a) alkyl(meth)acrylate units, and there is a problem that heat resistance of the optical film is lowered if the copolymer (A) comprises more than 99.9 parts by weight of (a) alkyl(meth)acrylate units. There is a problem in controlling a retardation of the optical film if the copolymer (A) comprises less than 0.1 part by weight of (b) styrene units, and haze is caused to impede transparency of the optical film, since there is a problem in properties of mixing the copolymer with the aromatic resin if the copolymer (A) comprises more than 10 parts by weight of (b) styrene units. There is a problem that heat resistance of the optical film deteriorates if the copolymer (A) comprises less than 0.1 part by weight of (c) 3 to 6 element heterocyclic units substituted with at least one carbonyl group, and a prepared optical film may be in a brittle state, since properties of the resin become unstable if the copolymer (A) comprises more than 10 parts by weight of (c) 3 to 6 element heterocyclic units substituted with at least one carbonyl group.

It is preferable that the copolymer (A) further comprising (c) 3 to 6 element heterocyclic units substituted with at least one carbonyl group and aromatic resin (B) are mixed in a weight ratio of 90:10 to 99.5:0.5. There may be a problem in controlling a retardation of the optical film if the copolymer is mixed with the aromatic resin to a mixing ratio that is less than the above-mentioned weight ratio, and there is a problem in properties of mixing the copolymer with the aromatic resin if the copolymer is mixed with the aromatic resin to a mixing ratio that is more than the above-mentioned weight ratio.

A resin composition according to the present invention can be prepared by blending the above-mentioned components according to methods well known in the art such as a compounding method, and melt mixing of the components can be carried out using an extruder and so on.

Further, the resin composition may comprise 0.01 to 1.0 part by weight of additives well known to the art such as a lubricant, an antioxidant, a UV stabilizer, a heat stabilizer and others that are commonly used.

An optical film according to the present invention can be formed using the resin composition that has been mentioned above. Specifically, an optical film according to the present invention can be prepared by a method comprising the step of forming a film after obtaining the resin composition, and the method may further comprise the step of uniaxially or biaxially stretching the film.

An optical film according to the present invention may be prepared using any method known in the art, specifically an extrusion molding method. For instance, the method may comprise the steps of vacuum drying the resin composition to remove water and dissolved oxygen therefrom, feeding the resin composition into a single or twin extruder that had been substituted with nitrogen from a raw material hopper to the extruder, melting resin composition to obtain raw material pellets, vacuum drying the obtained raw material pellets, melting the vacuum dried raw material pellets using a single extruder substituted with nitrogen from raw material hopper to the single extruder, passing the molten material through a coat hanger type T-die, and then passing the resultant material through a chromium-coated casting roll, drying rolls, and others to prepare a film. The method may further comprise the step of uniaxially or biaxially stretching the film.

Although an optical film formed using the resin composition of the present invention preferably has a thickness of 5 to 300 μm, its thickness is not limited thereto. The optical film has light transmittance of 90% or more, and has a haze value range of 2.5% or less, preferably 1% or less, and more preferably 0.5% or less. If the optical film has a light transmittance of less than 90% and a haze value of more than 2.5%, luminance of an LCD device in which such an optical film is used may be reduced.

It is preferable that an optical film according to the present invention has a glass transition temperature of 110° C. or more, and it is more preferable that the optical film has a glass transition temperature of 120° C. or more. Although the resin composition may have a glass transition temperature of 200° C. or less, the glass transition temperature thereof is not limited thereto. If the resin composition has a glass transition temperature of less than 110° C., insufficient heat resistance of the resin composition easily causes deformation of a film under high temperature and high humidity conditions to result in a problem that compensating characteristics of the film become uneven.

Further, it is preferable that the resin composition has a weight average molecular weight of 50,000 to 500,000 from the aspects of heat resistance, formability, and productivity.

It is preferable that an optical film according to the present invention can be prepared to be used as a polarizing plate-protecting film. Particularly, a polarizing plate has a structure in which a triacetyl cellulose (TAC) film as a protection film is generally laminated on a polarizer using a waterborne adhesive comprised of an aqueous polyvinyl alcohol-based solution. However, both the polyvinyl alcohol film used as the polarizer and the TAC film used as the protection film do not have sufficient heat resistance and humidity resistance. Therefore, the polarizing plate has various restrictions in the application aspect since as the degree of polarization deteriorates, the polarizer and protection film are separated from each other, or optical properties of the polarizer and protection film deteriorate if the polarizing plate comprised of the films is used for a long time in a high temperature or high humidity environment. Therefore, an optical film of the present invention can be used as a polarizer-protecting film that replaces such a protection film. A retardation of an optical film of the present invention can be defined according to the following expression, and the retardation is divided into an in-plane retardation (Rᵢₙ) and a thickness-directional retardation (Rₜₕ). Also, the measured reference wavelength of the in-plane retardation and the thickness retardation is 550 nm:

Rᵢₙ=(nₓ−n_{y})×d,

Rₜₕ=[(nₓ+n_{y})/2−n_{z}]]×d

wherein nₓ is the highest refractive index among in-plane refractive indexes of the optical film, n_{y} is a refractive index of a direction perpendicular to nₓ among the in-plane refractive indexes of the optical film, n_{z} is a thickness-directional refractory index of the optical film, and d is thickness of the film.

### Mode for Invention

Hereinafter, the present invention will be described in more detail, according to specific examples.

### EXAMPLES

### 1. Preparation of a Resin Composition According to the Present Invention

### Example 1

Raw material pellets were prepared by feeding a resin composition in which poly(N-cyclohexylmaleimide-co-methylmethacrylate-co-α-methylstyrene) and polycarbonate resin had been uniformly mixed in a weight ratio of 98:2 to a 24φ extruder that had been substituted with nitrogen from a raw material hopper to the extruder, thereby melting the resin composition at 250° C. A glass transition temperature (Tg) of the prepared resin was measured using a DSC, and measurement result was represented in the following table 1.

1080DVD (MFR: 80 g/10 min(300° C., 1.2 kg), and Tg=143° C.) by LG-Dow polycarbonate Co., Ltd. was used as the polycarbonate resin. As a result of NMR analysis, poly(N-cyclohexylmaleimide-co-methylmethacrylate-co-α-methylstyrene) comprised 6.0 wt. % of N-cyclohexylmaleimide and 2.0 wt. % of α-methylstyrene.

### Example 2

A glass transition temperature (Tg) was measured by the same method as in the Example 1 except that poly(N-cyclohexylmaleimide-co-methylmethacrylate-co-α-methylstyrene) and polycarbonate resin were uniformly mixed in a weight ratio of 94:6, and the measurement result is represented in the following table 1.

### Comparative Example 1

A glass transition temperature (Tg) was measured by the same method as in the Example 1 except that poly(N-cyclohexylmaleimide-co-methylmethacrylate-co-α-methylstyrene) and polycarbonate resin were uniformly mixed in a weight ratio of 100:0, and the measurement result is represented in the following table 1.

### Comparative Example 2

A glass transition temperature (Tg) was measured by the same method as in the Example 1 except that poly(methylmethacrylate) and polycarbonate resin were uniformly mixed in a weight ratio of 100:0, and the measurement result was represented in the following table 1.

### Comparative Example 3

A glass transition temperature (Tg) was measured by the same method as in the Example 1 except that poly(methylmethacrylate) and polycarbonate resin were uniformly mixed in a weight ratio of 98:2, and the measurement result was represented in the following table 1.

### Comparative Example 4

A glass transition temperature (Tg) was measured by the same method as in the Example 1 except that poly(N-cyclohexylmaleimide-co-methylmethacrylate-co-α-methylstyrene) and polycarbonate resin were uniformly mixed in a weight ratio of 89:11, and the measurement result was represented in the following table 1.

### Comparative Example 5

A glass transition temperature (Tg) was measured by the same method as in the Example 1 except that poly(N-cyclohexylmaleimide-co-methylmethacrylate-co-α-methylstyrene) and polycarbonate resin were uniformly mixed in a weight ratio of 83:17, and the measurement result was represented in the following table 1.

TABLE 1

| | Mixing ratio (%) | Tg (° C.) |
|---|---|---|
| Example 1 | 98:2 | 126 |
| Example 2 | 94:6 | 126 |
| Comparative | 100:0 | 124 |
| Example 1 | | |
| Comparative | 100:0 | 100 |
| Example 2 | | |
| Comparative | 98:2 | 101 |
| Example 3 | | |
| Comparative | 89:11 | 126 |
| Example 4 | | |
| Comparative | 83:17 | 126 |
| Example 5 | | |

### 2. Preparation of an Optical Film Using a Resin Composition According to the Present Invention

A film having a thickness of 240 μm was prepared by passing the molten material through a coat hanger type T-die and passing the resultant material through a chromium-coated casting roll, drying rolls, and others after vacuum drying raw material pellets obtained in Examples 1 and 2 and Comparative Examples 1 to 5 and melting the vacuum dried raw material pellets at 250° C. by an extruder.

The film was biaxially stretched to a ratio listed in Table 2 in MD and TD directions at a temperature range of 129 to 133° C. which was 5° C. higher than the glass transition temperature (Tg) of each film using testing film stretching equipment in order to prepare a biaxially stretched film. In-plane and thickness-directional retardation values of the film were represented by the following Table 2.

TABLE 2

| | Stretching | | | | | |
|---|---|---|---|---|---|---|
| | temperature | Stretching ratio (%) | | Retardation (nm) | | Thickness |
| | (° C.) | MD | TD | Rᵢₙ | Rₜₕ | (μm) |
| Example 1 | 131 | 100 | 0 | 7.8 | −16.9 | 105 |
| Example 2 | 131 | 100 | 100 | 0.6 | −9.5 | 60 |
| Comparative | 129 | 100 | 100 | 2.1 | −81.1 | 60 |
| Example 1 | | | | | | |
| Comparative | 105 | 100 | 0 | 31 | −46.5 | 105 |
| Example 2 | | | | | | |
| Comparative | 106 | 100 | 0 | 12 | −26.0 | 105 |
| Example 3 | | | | | | |
| Comparative | 131 | 100 | 100 | 3.1 | 55.4 | 60 |
| Example 4 | | | | | | |
| Comparative | 131 | 100 | 0 | 41 | −61.5 | 100 |
| Example 5 | | | | | | |

As can be seen through the Examples, it can be confirmed that an optical film according to an optical film can obtain values near zero as absolute values of in-plane retardation and thickness-directional retardation by controlling the mixing ratio.

While the present invention has been shown and described in connection with the embodiments, it will be apparent to those skilled in the art that modifications and variations can be made without departing from the spirit and scope of the invention as defined by the appended claims.

1. A resin composition comprising:
(A) a copolymer including (a) alkyl(meth)acrylate units and (b) styrene units; and
(B) an aromatic resin having carbonate moieties in the main chain.

2. The resin composition of claim 1, wherein alkyl moieties of the (a) alkyl(meth)acrylate units are a methyl group or an ethyl group.

3. The resin composition of claim 1, wherein the (b) styrene units comprise substituted styrene wherein a benzene ring or vinyl groups of the styrene is substituted with one or more substituents selected from groups consisting of C₁₋₄ alkyl and halogen groups.

4. The resin composition of claim 1, wherein the aromatic resin (B) having carbonate moieties in the main chain comprises 5 to 10,000 of at least one species of unit represented by the following formula I: 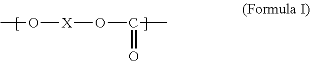
wherein X is a bivalent group comprising at least one benzene ring.

5. The resin composition of claim 1, wherein the X is a bivalent group selected from the group consisting of the following structural formulas:

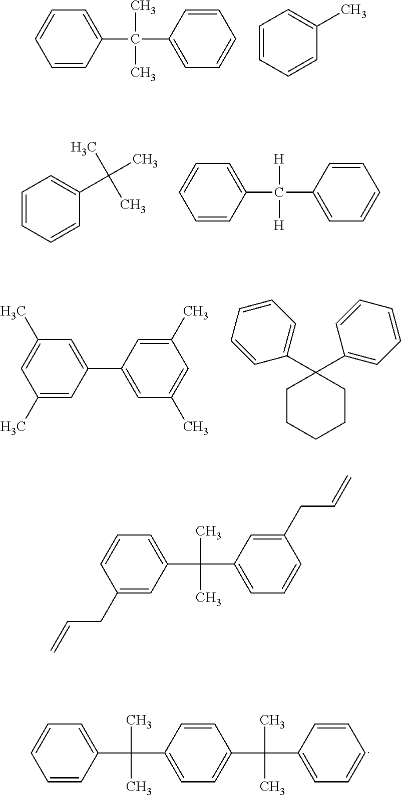

6. The resin composition of claim 1, wherein the copolymer (A) comprises 80 to 99.9 parts by weight of (a) alkyl(meth)acrylate units and 0.1 to 20 parts by weight of (b) styrene units with respect to 100 parts by weight of the copolymer.

7. The resin composition of claim 1, wherein the copolymer (A) and the aromatic resin (B) are mixed in a weight ratio of 90:10 to 99.5:0.5.

8. The resin composition of claim 1, wherein the copolymer (A) further comprises (c) 3 to 6 element heterocyclic units substituted with at least one carbonyl group.

9. The resin composition of claim 8, wherein the (c) 3 to 6 element heterocyclic units substituted with at least one carbonyl group are selected from the group consisting of maleic anhydride, maleimide, glutaric anhydride, glutarimide, lactone, and lactam.

10. The resin composition of claim 8, wherein the copolymer (A) comprises a combination of 2 member copolymers selected from the group consisting of (a) alkyl(meth)acrylate units, (b) styrene units, and (c) 3 to 6 element heterocyclic units substituted with at least one carbonyl group.

11. The resin composition of claim 8, wherein the copolymer (A) comprises 80 to 99.9 parts by weight of (a) alkyl(meth)acrylate units, 0.1 to 10 parts by weight of (b) styrene units, and 0.1 to 10 parts by weight of (c) 3 to 6 element heterocyclic units substituted with at least one carbonyl group with respect to 100 parts by weight of the copolymer.

12. The resin composition of claim 8, wherein the copolymer (A) and the aromatic resin (B) are mixed in a weight ratio of 90:10 to 99.5:0.5.

13. The resin composition of claim 1, wherein the resin composition is a compound resin.

14. An optical film formed using a resin composition of any one of claim 1.

15. The optical film of claim 14, wherein the optical film is a protection film for polarizing plate.

16. The resin composition of claim 1, wherein the aromatic resin (B) having carbonate moieties in the main chain is polycarbonate resin.
